(19) United States
(12) Patent Application Publication
(10) Pub. No.: US 2020/0093079 A1
(43) Pub. Date: Mar. 26, 2020

(54) PLANT WATERING ASSEMBLY

(71) Applicant: Christine Fink, Yorkville, IL (US)

(72) Inventor: Christine Fink, Yorkville, IL (US)

(21) Appl. No.: 16/140,646

(22) Filed: Sep. 25, 2018

(51) Int. Cl. A01G 27/02; A01G 13/02

(52) U.S. Cl. CPC A01G 27/02; A01G 13/0243

(57) ABSTRACT

A plant watering assembly for retaining water around a plant includes a canister that is positionable around a plant. The canister is comprised of a fluid impermeable material thereby facilitating a fluid to be poured therein. Thus, the canister retains the fluid around the plant for nourishing the plant. The canister has a plurality of spikes thereon and each of the spikes pierces ground when the canister is positioned around the plant. In this way the spikes inhibit the canister from being displaced.

### CROSS-REFERENCE TO RELATED APPLICATIONS

### Statement Regarding Federally Sponsored Research or Development

Not Applicable

### The Names of the Parties to a Joint Research Agreement

Not Applicable

### Incorporation-by-Reference of Material Submitted on A Compact Disc or as a Text File Via the Office Electronic Filing System

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to watering devices and more particularly pertains to a new watering device for retaining water around a plant.

### BRIEF SUMMARY OF THE INVENTION

An embodiment of the disclosure meets the needs presented above by generally comprising a canister that is positionable around a plant. The canister is comprised of a fluid impermeable material thereby facilitating a fluid to be poured therein. Thus, the canister retains the fluid around the plant for nourishing the plant. The canister has a plurality of spikes thereon and each of the spikes pierces ground when the canister is positioned around the plant. In this way the spikes inhibit the canister from being displaced.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective phantom view of a plant watering assembly according to an embodiment of the disclosure.

FIG. 2 is a top view of an embodiment of the disclosure.

FIG. 3 is a front view of an embodiment of the disclosure.

FIG. 4 is a cut-away in-use view of an embodiment of the disclosure.

### DETAILED DESCRIPTION OF THE INVENTION

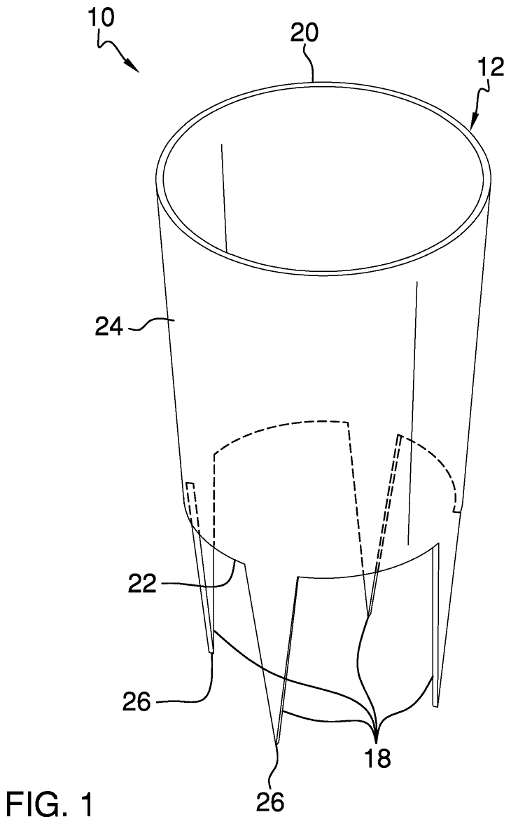

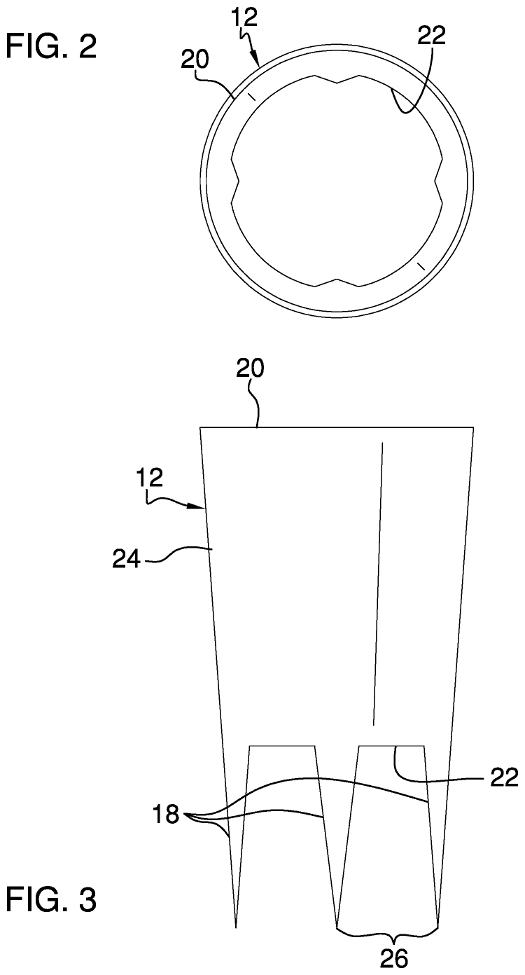

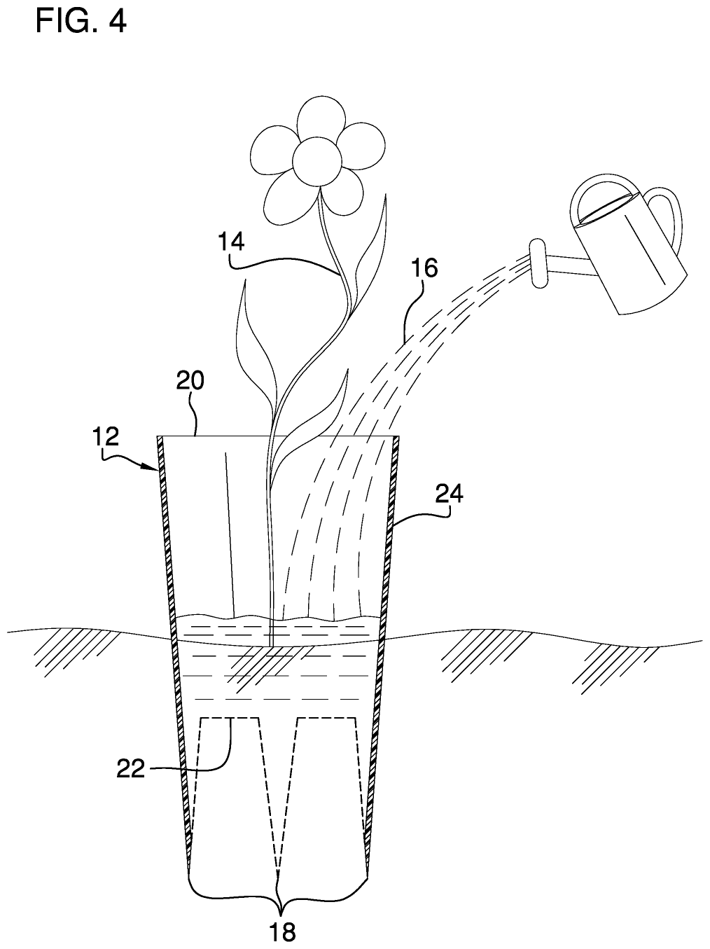

With reference now to the drawings, and in particular to FIGS. 1 through 4 thereof, a new watering device embodying the principles and concepts of an embodiment of the disclosure and generally designated by the reference numeral 10 will be described.

As best illustrated in FIGS. 1 through 4, the plant watering assembly 10 generally comprises a canister 12 that is positionable around a plant 14, such as a flower, a vegetable plant 14 and any other plant 14 that can be conscientiously grown. The canister 12 is comprised of a fluid impermeable material such as plastic, steel or other rigid material. A fluid 16, such as water, a fluid fertilizer other fluid commonly used to water a plant 14, is poured into the canister 12. Thus, the canister 12 retains the fluid 16 around the plant 14 for nourishing the plant 14. The canister 12 has a plurality of spikes 18 thereon and each of the spikes 18 pierces ground when the canister 12 is positioned around the plant 14. In this way the spikes 18 inhibit the canister 12 from being displaced from around the plant 14.

The canister 12 has a top end 20, a bottom end 22 and an outer wall 24 extending therebetween, and each of the top 20 and bottom 22 ends is open. The outer wall 24 tapers inwardly between the top 20 and bottom 22 ends such that the top end 20 has a diameter that is greater than a diameter of the bottom end 22. Each of the spikes 18 is positioned on and extends downwardly from the bottom end 22, and the spikes 18 are spaced apart from each other and are distributed around the bottom end 22. Each of the spikes 18 has a distal end 26 with respect to the bottom end 22 and each of the spikes 18 tapers to a point between the canister 12 and the distal end 26.

In use, the canister 12 is positioned around the plant 14 and the canister 12 is urged downwardly until the spikes 18 pierce the ground such that the bottom end 22 of the canister 12 is positioned below the ground. A selected amount of the fluid 16, based upon the watering needs of the plant 14, is poured into the canister 12. Thus, the canister 12 retains the selected amount of fluid 16 around the plant 14, thereby facilitating the fluid 16 to soak into the ground around the plant 14 and nourish the roots of the plant 14. Additionally, the canister 12 inhibits the fluid 16 from running off when the plant 14 is watered thereby facilitating the plant 14 to fully benefit from the nourishment of the fluid 16. The canister 12 is removable from around the plant 14 at any time.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A plant watering assembly being configured to be positioned around a plant thereby retaining water around the plant, said assembly comprising:
a canister being positionable around a plant, said canister being comprised of a fluid impermeable material, said canister having a fluid poured therein wherein said canister is configured to retain the fluid around the plant for nourishing the plant, said canister having a plurality of spikes thereon, each of said spikes piercing ground when said canister is positioned around the plant wherein said spikes are configured to inhibit said canister from being displaced.

2. The assembly according to claim 1, wherein said canister has a top end, a bottom end and an outer wall extending therebetween, each of said top and bottom ends being open, said outer wall tapering inwardly between said top and bottom ends such that said top end has a diameter being greater than a diameter of said bottom end.

3. The assembly according to claim 1, wherein:
said canister has a bottom end; and
each of said spikes is positioned on and extends downwardly from said bottom end, said spikes being spaced apart from each other and being distributed around said bottom end, each of said spikes having a distal end with respect to said bottom end, each of said spikes tapering to a point between said canister and said distal end.

4. A plant watering assembly being configured to be positioned around a plant thereby retaining water around the plant, said assembly comprising:
a canister being positionable around a plant, said canister being comprised of a fluid impermeable material, said canister having a fluid poured therein wherein said canister is configured to retain the fluid around the plant for nourishing the plant, said canister having a plurality of spikes thereon, each of said spikes piercing ground when said canister is positioned around the plant wherein said spikes are configured to inhibit said canister from being displaced, said canister having a top end, a bottom end and an outer wall extending therebetween, each of said top and bottom ends being open, said outer wall tapering inwardly between said top and bottom ends such that said top end has a diameter being greater than a diameter of said bottom end, each of said spikes being positioned on and extending downwardly from said bottom end, said spikes being spaced apart from each other and being distributed around said bottom end, each of said spikes having a distal end with respect to said bottom end, each of said spikes tapering to a point between said canister and said distal end.
